(19) United States
(12) Patent Application Publication
(10) Pub. No.: US 2024/0411634 A1
(43) Pub. Date: Dec. 12, 2024

(54) ANALYSIS DEVICE AND ANALYSIS DEVICE ASSISTANCE SYSTEM

(71) Applicant: KYOTO ELECTRONICS MANUFACTURING CO., LTD., Kyoto-shi, Kyoto (JP)

(72) Inventors: Nobuaki WATANABE, Kyoto-shi (JP); Takashi MATSUKI, Kyoto-shi (JP); Hidenori MATSUOKA, Kyoto-shi (JP); Ikumi KUROSE, Kyoto-shi (JP)

(73) Assignee: KYOTO ELECTRONICS MANUFACTURING CO., LTD., Kyoto-shi, Kyoto (JP)

(21) Appl. No.: 18/274,100

(22) PCT Filed: Feb. 22, 2022
(86) PCT No.: PCT/JP2022/007155

§ 371 Date: Jul. 25, 2023

(30) Foreign Application Priority Data
Feb. 26, 2021 (JP) 2021-030846

(51) Int. Cl. G06F 11/07

(52) U.S. Cl. CPC G06F 11/079; G06F 11/0709

(57) ABSTRACT

This analysis device can transmit or move measurement data to a target place. An export instruction unit issues a data export instruction of user. A data designation unit designates a specific measurement data item to be moved, among a plurality of types of measurement data items stored in a memory, on the basis of the instruction from the export instruction unit. A format conversion unit converts the measurement data item designated by the data designation unit into a data format suited for a relay medium from the analysis device. The measurement data item, the data format of which has been converted, is outputted by an output unit. For the relay medium, a two-dimensional code or a contactless IC chip can be used.

### TECHNICAL FIELD

This invention relates to analysis devices, in particular, relates to analysis devices that facilitate exporting and importing measurement data, and fixing errors.

### BACKGROUND ART

The analysis objects of the water quality measurement and the hazardous substances measurement are the river, the factory drainage, and the exhaust gas from the factory. The location for the measurement operation may be different from the location for the analyzing operation for the measurement data, such as the laboratory. In addition, a person operating the measurement may be different from a person requiring the measurement data. Furthermore, there is a case that is necessary to share a specific measurement data with many persons.

In the above case, a user of the analysis device has to transmit the measurement data stored in a memory of the analysis device to the location requiring the measurement data, such as the laboratory, in the middle of or after the end of the measurement operation.

When the user uses the analysis device not provided with the a communication unit and has to transmit the obtained measurement data to a location different from the user's location, the user usually connects the analysis device to a laptop computer or a tablet terminal provided with the communication function via USB cable, and exports or copies the target measurement data to a memory of the laptop computer or the tablet terminal, and then transmits the exported or copied measurement data to the target location (an electronic device) via communication.

On the other hands, when an error occurs in the analysis device, the user contacts the manufacturer of the analysis device and then restores the errors according to the manufacturer's instruction, or the manufacturer restores the errors on its side. At this time, the manufacturer specifies the cause of error according to the data to specify the device (e.g. a production serial number), a software version installed in the device, a kind of error (e.g. an error number), an operating status (log) of the software when the error occurs, and the measurement data before and after the error occurs. According the specified error, the manufacturer gives necessary instructions to the user, or takes a necessary step by them.

The above-mentioned data should be collected by the user at the measurement location, and transmitted to the manufacturer by e-mail or telephone.

### CITATION LIST

### Patent Literature

None

### Non Patent Literature

None

### SUMMARY OF INVENTION

### Technical Problem

In case of transmitting the measurement data to the other electronic device requiring the data (hereinafter referred to “destination electronic device”), it is necessary to temporarily export or copy the target measurement data to the laptop computer or the tablet terminal provided with the communication function. This is very troublesome for the user. Since the raw data is treated between the devices, there is a risk of leakage to the third party in case of confidential data.

Moreover, when an error occurs in the analysis device, the user collects necessary data and transmit the data with the product serial number, and so on, of the analysis device to the manufacturer by e-mail or telephone. In such case, either the user or the manufacturer is required to input the necessary data by a keyboard or a writing tool, and it is very troublesome operation and may cause an input error. In addition, when the manufacturer requires all or a part of the measurement data, the confidentiality may be leaked during the transaction of data.

The present invention is proposed in view of the above-mentioned conventional art, and has as an object to provide an analysis device and an analysis device assistance system, wherein the measurement data can be exported or transmitted to the target place with keeping the confidentiality and in a simple manner, and moreover, it is possible for both the user and the manufacturer to restore the error without using the writing tool and inputting by the keyboard.

### Solution to Problem

The analysis device in accordance with the present invention is proposed in view of the above problem in the conventional art, and includes a format conversion unit, a data designation unit, an export instruction unit, and an output unit as described hereinafter.

In the analysis device of the present invention, the export instruction unit issues an export instruction of a user to “export measurement data to a destination electronic device”. The data designation unit designates a specific measurement data to be exported among a plurality of types of measurement data stored in a memory according to the instruction of the export instruction unit. The format conversion unit converts the specific measurement data designated by the data designation unit into a data format suitable for a relay medium for giving the data from the analysis device to the destination electronic device. The format-converted measurement data is outputted by the output unit.

The relay medium used for giving the data from the analysis device to the destination electronic device may be a two-dimensional code or a contactless IC chip, as described hereinafter. Accordingly, the output unit of the analysis device may be a display unit for displaying the two-dimensional code when the relay medium for giving the data from the analysis device to the destination electronic device is the two-dimensional code, otherwise, it may be a writer for the IC chip when the relay medium for giving the data from the analysis device to the destination electronic device is the contactless IC chip.

The analysis device assistance system of the present invention further includes a repeater and the destination electronic device.

In the repeater, an import unit imports the format-converted data from the output device, and a transmission unit transmits the format-converted measurement data imported by the import unit to the destination electronic device via communication.

Additionally, in the destination electronic device, a receiving unit receives the transmission from the repeater, and a decoding unit decodes the received data to the original measurement data.

As described above, where the relay medium for giving the data to the destination electronic device is the two-dimensional code, the import unit of the repeater is a camera, and where the relay medium is the contactless IC chip, the import unit is a reader for reading the contents of the contactless IC chip. In addition, a decoder corresponding to the two-dimensional code or the IC chip is used as the decoding unit of the destination electronic device.

The above describes the data moving via communication, but it is not necessary to use the communication. In such case, the output unit of the repeater can be employed.

That is to say, the format-converted measurement data imported by the import unit of the repeater is outputted from the output unit of the repeater. The destination electronic device is provided with the import unit, and decodes to the original format measurement data from the format-converted measurement data outputted from the output unit of the repeater. The destination electronic device may be another analysis device, in this case.

The output unit of the repeater is a display unit when the relay medium for giving the data to the destination electronic device is the two-dimensional code, or a writer for an IC chip when the relay medium is the IC chip.

The configuration relevant to the moving of the measurement data can be utilized for restoring errors.

That is to say, an error detection unit is provided to the analysis device. When the error detection unit detects an error, a data extraction unit starts up and extracts error data necessary for the error analysis. According to the error data extracted by the data extraction unit, the format conversion unit converts the error data to the data format suitable for the relay medium for relaying the error data to the destination electronic device for the error management, and the format-converted error data is outputted by the output unit.

Likewise the transmission of the measurement data, the error data in a specific format outputted by the output unit of the analysis device as described above is imported by the import unit of the repeater, and then transmitted by the transmission unit to the destination electronic device for the error management. The destination electronic device for the error management decodes the received specific format error data to the error data in an original format. And, an error analysis unit analyzes causes of the error by hand or by an application program, and sends back the analysis result to the repeater of the user.

The error data for the error analysis are data items for specifying the device, for specifying the version of the software in use, for specifying the type of error, the log data indicating the operation condition of the software before and after the error occasion, and all or a part of measurement data obtained by the measurement operation before and after the error occasion.

### Advantageous Effects of Invention

According to the above configuration, the user can transmit the measurement data to the destination receiver requesting the data without exporting (copying) the measurement data to the laptop computer or the tablet terminal. In addition, where the user does not have a writing tool or a keyboard when the error occurs, the user can transmit the requested error data to the manufacturer.

### BRIEF DESCRIPTION OF DRAWINGS

FIG. 1 is a block diagram showing an embodiment of exporting measurement data 1 in accordance with the present invention;

FIG. 2 is a block diagram showing an embodiment of exporting measurement data 2 in accordance with the present invention; and

FIG. 3 is a block diagram showing the embodiment of the error detection in accordance with the present invention.

### DESCRIPTION OF EMBODIMENTS

### <Exporting Measurement Data 1>

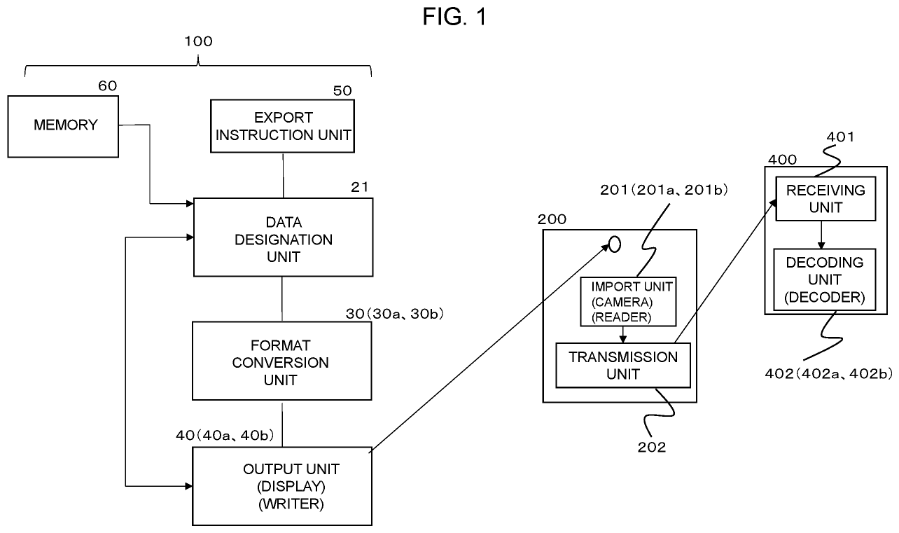

FIG. 1 is a block diagram showing an embodiment of the present invention.

A memory 60 in an analysis device 100 stores a plurality of types of measurement data in the middle of and after the measurement operation. There are various ways for storing the measurement data in the memory 60, but it is general that the measurement data are stored in corresponding files every measurement operation, and each file stores more detailed measurement data measured in different conditions.

There is a case where a user of the analysis device 100 wants to transmit all or a part of the measurement data to another laptop computer, a tablet terminal, and etc. (hereinafter referred to a destination electronic device 400) that requires the measurement data.

First, the user needs to issue an export instruction that “export the measurement data toward the destination electronic device” by means of an export instruction unit 50 consisting of a soft key board or a hard key board.

Upon receipt of the export instruction issued by the user as above, a data designation unit 21 reads and displays a list of files stored in the memory 60 on a display unit 40. The user designates a target file to be exported among the file groups displayed as the list. When the data designation unit 21 has an editing function, the user may designate a specific measurement data in the designated file.

After the target file to be exported is designated as above, the data designation unit 21 gives the designated file (the measurement data) to an encoder 30a as a format conversion unit 30.

The encoder 30a converts the measurement data group of the designated target file to a data format suitable for the two-dimensional code that is a relay medium for relaying the data to the destination electronic device. The converted data is given to a display 40a as an output unit 40, and the two-dimensional code is displayed thereon.

On the other hands, a repeater 200 described hereinafter is provided with the communication function and the camera function, that is to say, a smartphone or a tablet terminal can be applied.

In the repeater 200, a camera 201a is used as an import unit 201 for importing the two-dimensional code, and imports an image of the displayed two-dimensional code. And the measurement data converted to the two-dimensional code is transmitted to the destination electronic device 400 by a transmission unit 202 of the repeater 200.

A receiving unit 401 of the destination electronic device 400 gives the received two-dimensional code image to a decoder 402a as a decoding unit 402, and the decoder 402a decodes the two-dimensional code image to the measurement data in an original data format.

According to the above process, even if the analysis device is not provided with the communication unit, it is possible to export the data in ease by using the two-dimensional code and the repeater like the smartphone.

### <Exporting Measurement Data 2>

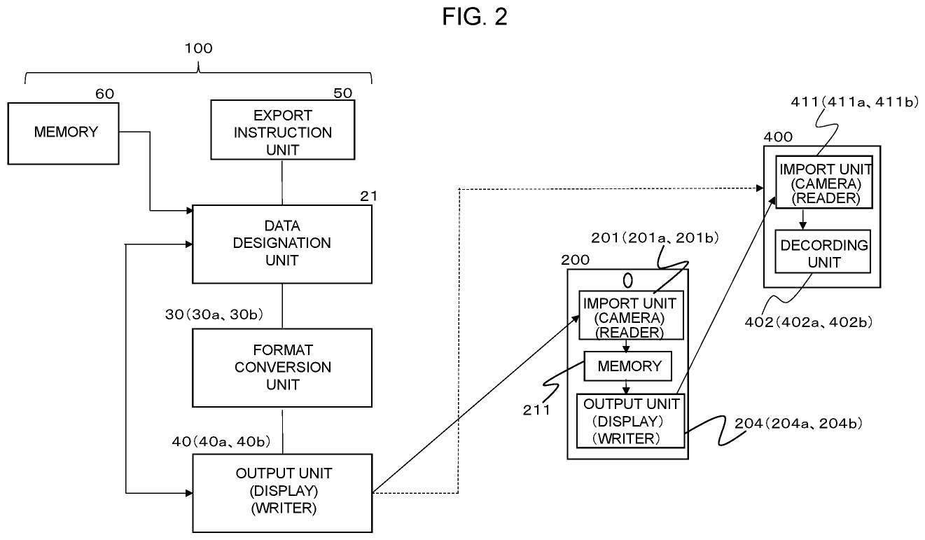

FIG. 2 shows the other embodiment of the present invention.

Where the destination electronic device 400 is located nearby the user and provided with a camera 411a as an import unit 411, the data export can be executed without using the communication function.

That is to say, the two-dimensional code, that the user of the analysis device imported as an image through the camera 201a as the import unit 201, can be stored in a memory 211 of the repeater 200 without change. The two-dimensional code can be displayed as it is on a display unit 204 as an output unit of the repeater 200. In such manner, the two-dimensional code displayed on the display 204a is imported by the camera 411a as the import unit 411 of the destination electronic device 400, and then given to the decoder 402b as the decoding unit 402, whereby the measurement data can be exported to the electronic device 400.

As the electronic device 400, it is possible to use an other analysis device different from the analysis device storing the measurement data. That is to say, where the measurement operation being worked on a specific analysis device is taken over to the other analysis device, it is necessary to export (copy) the measurement data up to the present to the analysis device taking over the measurement operation. In such case, it is possible to response to such request quickly.

The above description only refers to the data export from the analysis device provided with the format conversion unit to the other analysis device provided with the decoding unit for decoding the format-converted data to the original format, but it is real as the product that both the format conversion unit and the decoding unit are provided to an analysis device in order to export and import the data from and to the other analysis device.

### <Error Detection>

A signal of the export instruction issued from the export instruction unit 50 is replaced with an error signal indicating the error occurrence in the analysis device, so that the error occurrence can be notified to a destination electronic device for the error management. As the destination electronic device for the error management, the electronic device located at the manufacturer is used.

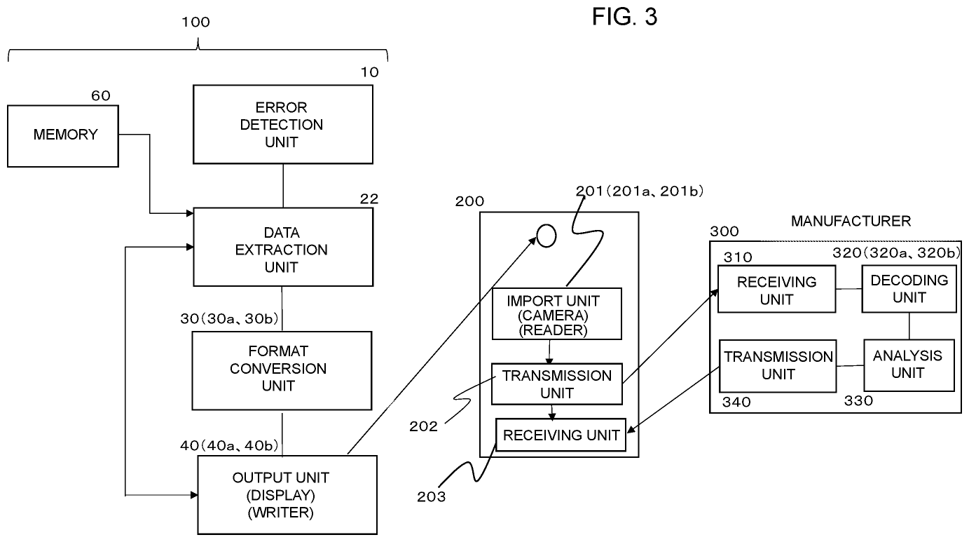

FIG. 3 is a system diagram showing a process of requesting the manufacturer to restore the error when the error occurs in the analysis device.

When the error occurs in the analysis device 100, the user has to fix the error in the device. At this time, it needs to specify a cause of error. As data for specifying the cause of error, there are information for specifying the analysis device, such as, a product serial number, a product model, a version of a software installed in the analysis device, and so on. Moreover, according to the fact that the quality of the measurement data changes before and after the break-down when the analysis device has failed, it is possible to associate the error with the change of the measurement data before and after the break-down. In addition, it is possible to associate the processing contents of the program with the error by monitoring the program operating condition (Log).

In view of the above matters, an error detection unit 10 for recognizing the error occurrence is provided to the analysis device. The error detection unit 10 starts up by capturing a signal notifying the error occurrence in the analysis device. The signals notifying the error occurrence are “E-01: Communication error”, “E-02: Connection error”, and etc., that are rough information of the error content, and signals issued from sensors placed on necessary points.

Upon receipt of the notice of the error occurrence from the error detection unit 10, a data extraction unit 22 collects error data for the error analysis. Here, the “error data for the error analysis” is the data for specifying the device, the software version installed in the device, the log indicating the time-dependent operation status of the software, the measurement data before and after the error occurrence, and so on, as described before.

In order to obtain the error data for the error analysis as described above, the data extraction unit 22 needs to know an address of a nonvolatile memory storing the product serial number of the analysis device and the version information of the software. And the data extraction unit 22 also needs in advance to know an address of a memory storing the log. Moreover, the extraction unit 22, in order to obtain the measurement data, needs to access a corresponding file in the memory 60 storing the measurement data. In this case, the measurement data may be all the measurement data of the corresponding file, or a specific number of measurement data before and after the error occurrence.

Besides, there is a case where the error data requested by the manufacturer are different depending on the type of error. In such case, it may be configured that the data extraction unit 22 extracts the necessary data after reading the type of error included in the error notice sent by the error detection unit 10, and otherwise, extracts all the data in associated with the error regardless the type of the error.

The error data extracted by the data extraction unit 22 as above are given to the encoder 30a as the format conversion unit 30, and then converted to the data format corresponding to the two-dimensional code that is a relay medium for relaying the data to the destination electronic device for the error management.

Besides, it may be configured that, after displaying the error data extracted by the data extraction unit 22 once on the display 40a, the user designates only the data requested by the manufacturer among the displayed data and gives them to the encoder 30a. In particular, where it is necessary to transmit the measurement data to the manufacturer, after once displaying all of the measurement data, the user designates the necessary data from those data. Thereby, since it is possible to reduce the number of the data and to keep the secret, it is very effective.

The two-dimensional code obtained as above is displayed on the display 40a. In case that the measurement data includes confidential matters for the user, the display of the two-dimensional code is very effective to preventing the leakage of the confidentiality.

The user imports the displayed two-dimensional code as an image to the camera 201a in the same manner as described above, and the camera is the import unit 201 of the repeater 200 such as a smartphone, etc. The imported image is transmitted to the destination electronic device 300 for the error management by means of the transmission unit 202 of the repeater 200. The destination electronic device 300 is provided with a receiving unit 310. The image of the two-dimensional code received by the receiving unit 310 is decoded to the error data in the original format by a decoder 320a as a decoding unit 320. According to the result decoded in such way, the manufacturer analyzes the condition of the analysis device, and sends the solution to the repeater 200 of the user. In the process of the analysis, it is possible to use an analysis unit 330 constituted of programs including AI. The analyzed result is transmitted to a receiving unit 203 of the user's repeater 200 through a transmission unit 340. Thereby, the user can take necessary steps for restoring the error.

As a result of using the repeater as the communication unit as described above, there is no need to provide the analysis device to the communication unit.

In the above description, the data extraction unit 22 is configured to start up upon receipt of the error notice from the error detection unit 10, however, the data extraction unit 22 may be configured to start up by an operation that the user pushes an “error data collection button” when the error detection unit 10 displays an error occurrence notice on the display device 40 (or the voice notice).

The error analysis on the manufacturer side is configured to be executed by the analysis unit 330 including the programs such as AI, and etc. Meanwhile, it may be configured that a person in charge executes the error analysis by hand. In such case, the report of the analysis result is also executed by the person.

### <Use of a Contactless IC Chip>

In the above-mentioned embodiments, the data (the measurement data, the error data) of the analysis device are converted to the format suitable for the two-dimensional code in the relaying stage, and then the converted data are moved to the destination electronic device including the destination electronic device for the error management, however, a contactless IC chip can be useful instead of the two-dimensional code.

In this case, the analysis device 100 employs an encoder 30b as a format conversion unit 30 for converting the measurement data (the error data) to a format suitable for the IC chip, and a writer 40b including the writing function as the output unit 40 for writing the converted data into the IC chip.

As the import unit 201 of the repeater, a reader 201b is employed for reading the converted measurement data (the converted error data) written into the IC chip. As the decoding unit 402 of the destination electronic device 400, the decoder 402b is employed for decoding the measurement data (the error data) written in the format suitable for the IC chip to the data in the original format. In addition, as the decoding unit 320 of the destination electronic device 300 for the error management, the decoder 320b is employed for decoding the error data in the format suitable for the IC chip to the error data in the original format.

Moreover, all the above descriptions are referred to the data moving via repeater, but in <Exporting Measurement Data 2>, as the destination electronic device is provided with the camera, it is possible to read directly the two-dimensional image of the measurement data displayed on the output unit (the display unit) of the analysis device. Where the destination electronic device is provided with the writer, it is possible to directly read the measurement data in the format suitable for the IC chip outputted from the output unit (the writer) of the analysis device (see FIG. 2, a broken line).

### INDUSTRIAL APPLICABILITY

As described above, it is configured in the present invention that, when the measurement data is transmitted to the destination device as a transmission target, the measurement data is converted to the two-dimensional code in the analysis device, and then transmitted through the repeater such as the user's smartphone or tablet terminal. Therefore, the analysis device is not required to be provided with the communication function and it is possible to keep the confidentiality. In addition, when the error occurs in the analysis device, since the user is able to transmit the error data to the manufacture without using the writing tools and a keyboard, the manufacture is able to do the troubleshooting quickly.

### REFERENCE SIGNS LIST

10 Error detection unit
21 Data designation unit
22 Data extraction unit
30 Format conversion unit
40 Output unit
50 Export instruction unit
60 Memory
100 Analysis device
200 Repeater
201 Import unit
202 Transmission unit
203 Receiving unit
204 Display
211 Memory
300 Destination electronic device for the error management
310 Receiving unit
320 Decoding unit
330 Analysis unit
340 Transmission unit
400 Destination electronic device
401 Receiving unit
402 Decoding unit
411 Import unit

1. An analysis device comprising:
an export instruction unit for issuing an export instruction of a user to “export measurement data to a destination electronic device”;
a data designation unit for designating specific measurement data to be exported among a plurality of types of the measurement data stored in a memory according to the instruction from the export instruction unit;
a format conversion unit for converting the specific measurement data designated by the data designation unit to a data format suitable for a relay medium used for relaying to the destination electronic device; and
an output unit for outputting the format-converted measurement data.

2. An analysis device assistance system including an analysis device, a repeater, and a destination electronic device, wherein,
the analysis device comprises:
an export instruction unit for issuing an export instruction of a user to “export measurement data to a destination electronic device”;
a data designation unit for designating a specific measurement data to be exported among a plurality of types of measurement data stored in a memory according to the instruction from the export instruction unit,
a format conversion unit for converting the specific measurement data designated by the data designation unit into a data format suitable for a relay medium used for relaying to the destination electronic device;
an output unit for outputting the format-converted measurement data; and
the repeater comprises:
an import unit for importing an output from the output unit of the analysis device;
a transmission unit for transmitting the format-converted measurement data imported by the import unit to the destination electronic device via communication; and
the destination electronic device comprises:
a receiving unit for receiving the transmission from the repeater; and
a decoding unit for decoding the received format-converted measurement data to the measurement data in an original format.

3. An analysis device assistance system including an analysis device, a repeater, and a destination electronic device, wherein,
the analysis device comprises:
an export instruction unit for issuing an export instruction of a user to “export measurement data to a destination electronic device”;
a data designation unit for designating a specific measurement data to be exported among a plurality of types of the measurement data stored in a memory according to the instruction from the export instruction unit;
a format conversion unit for converting the specific measurement data designated by the data designation unit to a data format compatible for a relay medium used for relaying to the destination electronic device;
an output unit for outputting the format-converted measurement data; and
the repeater comprises:
an import unit for importing the format-converted measurement data outputted from the output unit;
an output unit for outputting the format-converted measurement data imported by the import unit; and
the destination electronic device comprises:
an import unit for importing the format-converted measurement data outputted from the output unit of the repeater; and
a decoding unit for decoding the format-converted measurement data imported by the import unit to the measurement data in an original format.

4. The analysis device assistance system according to claim 3, wherein the destination electronic device is an other analysis device.

5. An analysis device comprising:
an error detection unit for detecting an error in operation;
a data extraction unit for starting up when the error detection unit detects the error, and extracting error data for the error analysis;
a format conversion unit for converting the error data extracted by the data extraction unit to a data format suitable for a relay medium for relaying to a destination electronic device for the error management; and
an output unit for outputting the format-converted error data.

6. The analysis device according to claim 5, wherein the error data for the error analysis includes data items for specifying the device, for specifying a version of a software in use, and for specifying a type of the error, and a log data indicating an operating condition of the software before and after the error occurrence, and all or a part of the measurement data obtained before and after the error occurrence.

7. An analysis device assistance system including an analysis device, a repeater, and a destination electronic device for the error management, wherein,
the analysis device comprises:
an error detection unit for detecting an error in operation;
a data extraction unit for starting up when the error detection unit detects the error, and extracting error data for the error analysis;
a format conversion unit for converting the error data extracted by the data extraction unit to a data format suitable for a relay medium relaying to the destination electronic device for the error management;
an output unit for outputting the format-converted error data; and
the repeater comprising:
an import unit for importing the format-converted error data outputted from the output unit;
a transmission unit for transmitting the format-converted error data imported from the import unit to the destination electronic device for the error management via communication; and
the destination electronic device for the error management comprises:
a receiving unit for receiving a transmission from the repeater; and
a decoding unit for decoding the format-converted error data received by the receiving unit to the error data in an original format.

8. The analysis device assistance system according to claim 7, the destination electronic device for the error management further comprising:
an error analysis unit for analyzing a cause of the error based on the format-decoded error data; and
a transmission unit for transmitting an analysis result of the error analysis unit to a receiving unit of user.

9. The analysis device assistance system according to claim 7, wherein the error data for the error analysis include data items for specifying the device, for specifying a version of a software in use, for specifying a type of error, and a log data indicating the operating condition of the software before and after the error occurrence, and all or a part of the measurement data obtained before and after the error occurrence.

10.-16. (canceled)

17. The analysis device according to claim 1, wherein the relay medium for relaying the data to the destination electronic device is a two-dimensional code, and the output unit is a display for displaying the two-dimensional code.

18. The analysis device according to claim 5, wherein the relay medium for relaying the data to the destination electronic device is a two-dimensional code, and the output unit is a display for displaying the two-dimensional code.

19. The analysis device according to claim 1, wherein the relay medium for relaying the data to the destination electronic device is a contactless IC chip, and the output unit is a writer for writing the data into the IC chip.

20. The analysis device according to claim 5, wherein the relay medium for relaying the data to the destination electronic device is a contactless IC chip, and the output unit is a writer for writing the data into the IC chip.

21. The analysis device assistance system according to claim 2, wherein the relay medium used for relaying the data to the destination electronic device is a two-dimensional code, the output unit of the analysis device is a display for displaying the two-dimensional code, and the import unit of the repeater is a camera.

22. The analysis device assistance system according to claim 7, wherein the relay medium used for relaying the data to the destination electronic device is a two-dimensional code, the output unit of the analysis device is a display for displaying the two-dimensional code, and the import unit of the repeater is a camera.

23. The analysis device assistance system according to claim 2, wherein the relay medium for relaying the data to the destination electronic device is an IC chip, the output unit of the analysis device is a writer for writing the data into the IC chip, and the import unit of the repeater is a reader for reading the data of the IC chip.

24. The analysis device assistance system according to claim 7, wherein the relay medium for relaying the data to the destination electronic device is an IC chip, the output unit of the analysis device is a writer for writing the data into the IC chip, and the import unit of the repeater is a reader for reading the data of the IC chip.

25. The analysis device assistance system according to claim 3, wherein the relay medium for relaying the data to the destination electronic device is a two-dimensional code, the output unit of the analysis device is a display for displaying the two-dimensional code, the import unit of the repeater is a camera, the output unit of the repeater is the display, and the import unit of the destination electronic device is a camera.

26. The analysis device assistance system according to claim 3, wherein the relay medium for relaying the data to the destination electronic device is an IC chip, the output unit of the analysis device is a writer for writing the data into the IC chip, the import unit of the repeater is a reader for reading the data in the IC chip, the output unit of the repeater is the writer, and the import unit of the destination electronic device is the reader.

27. The analysis device assistance system according to claim 3, wherein the destination electronic device comprises:
an import unit for importing the format-converted measurement data outputted from the output unit of the analysis device;
a decoding unit for decoding the format-converted measurement data imported by the import unit to the measurement data in the original format.
